(19) United States
(12) Patent Application Publication
(10) Pub. No.: US 2016/0274843 A1
(43) Pub. Date: Sep. 22, 2016

(54) DATA TRANSMISSION DEVICE, DATA TRANSMISSION SYSTEM, AND COMPUTER-READABLE RECORDING MEDIUM

(71) Applicant: Shohgo KUMAGAI, Kanagawa (JP)

(72) Inventor: Shohgo KUMAGAI, Kanagawa (JP)

(21) Appl. No.: 15/071,708

(22) Filed: Mar. 16, 2016

(30) Foreign Application Priority Data
Mar. 20, 2015 (JP) 2015-057195

(51) Int. Cl. G06F 3/12

(52) U.S. Cl. CPC G06F 3/1245; G06F 3/1204; G06F 3/1247; G06F 3/1248; G06F 3/1287

(57) ABSTRACT

A data-transmission device includes a first converting unit, multiple second converting units, a transmission-destination-determining unit, a file-transmitting unit, and a format-setting unit. The first converting unit converts target data to be printed into an intermediate format and activates the transmission-destination-determining unit. The transmission-destination-determining unit determines a transmission destination device in accordance with activation by the first converting unit, determines a file format that needs to be received by the transmission destination device, and gives a print command to one of the second converting units, which is capable of conducting conversion into the determined file format, when receiving a print command from the transmission-destination-determining unit. The second converting unit converts the target data converted into the intermediate format into the file format that needs to be received by the transmission destination device. The file transmitting unit transmits, to the transmission destination device, the target data converted into the file format.

### CROSS-REFERENCE TO RELATED APPLICATIONS

The present application claims priority to and incorporates by reference the entire contents of Japanese Patent Application No. 2015-057195 filed in Japan on Mar. 20, 2015.

### BACKGROUND OF THE INVENTION

1. Field of the Invention

The present invention relates to a data transmission device, a data transmission system, and a computer-readable recording medium.

2. Description of the Related Art

Computer programs, called virtual printer drivers, are known. The virtual printer driver is recognized as a printer driver by, for example, an application program for document preparation, or the like. The virtual printer driver receives a print command from the application program and performs data processing except for the control on transmission of print data to a printer.

For example, the virtual printer driver converts the data, received from the application program, into a predetermined file format (e.g., portable document format (PDF)) and delivers the converted data to a different module, which transmits it to a different device, thereby transmitting it to a different device via network. In the system that uses the above-described virtual printer driver, for each device that is a transmission destination, it is possible to conduct conversion into the file format that needs to be received by the device and transmit it.

However, in the system that uses the above-described virtual printer driver, users need to manually make settings so as to change the file format that needs to be received by a device. Furthermore, users need to check whether the virtual printer driver and the operating system are compatible with a new file format during manual settings.

In view of the above-described conventional technology, there is a need to provide a data transmission device, a data transmission system, and a computer-readable recording medium having a computer program that make it possible to easily set the file format that needs to be received by a device.

### SUMMARY OF THE INVENTION

It is an object of the present invention to at least partially solve the problems in the conventional technology.

According to exemplary embodiments of the present invention, there is provided a data transmission device that is capable of communicating with multiple devices via a network, the data transmission device comprising: a first converting unit that converts data into a predetermined intermediate format in accordance with a print command; multiple second converting units that convert data into different file formats in accordance with a print command; a transmission-destination determining unit that determines any of the devices as a transmission destination device; a file transmitting unit that transmits data to the transmission destination device; and a format setting unit that sets a file format that needs to be received by each device in accordance with designation from each device, wherein when receiving a print command for target data, the first converting unit converts the target data into the intermediate format and activates the transmission-destination determining unit, the transmission-destination determining unit determines the transmission destination device in accordance with activation by the first converting unit, determines a file format that needs to be received by the transmission destination device, and gives a print command to any one of the second converting units, which is capable of conducting conversion into the determined file format, when receiving a print command from the transmission-destination determining unit, the second converting unit converts the target data, converted into the intermediate format by the first converting unit, into the file format that needs to be received by the transmission destination device, and the file transmitting unit transmits, to the transmission destination device, the target data that has been converted into the file format that needs to be received by the transmission destination device.

Exemplary embodiments of the present invention also provide a data transmission system comprising multiple devices and a data transmission device that is capable of communicating with the devices via a network, wherein the data transmission device includes a first converting unit that converts data into a predetermined intermediate format in accordance with a print command; multiple second converting units that convert data into different file formats in accordance with a print command; a transmission-destination determining unit that determines that any of the devices is a transmission destination device; a file transmitting unit that transmits data to the transmission destination device; and a format setting unit that sets a file format that needs to be received by each device in accordance with designation from each device, wherein when receiving a print command for target data, the first converting unit converts the target data into the intermediate format and activates the transmission-destination determining unit, the transmission-destination determining unit determines the transmission destination device in accordance with activation by the first converting unit, determines a file format that needs to be received by the transmission destination device, and gives a print command to any one of the second converting units, which is capable of conducting conversion into the determined file format, when receiving a print command from the transmission-destination determining unit, the second converting unit converts the target data, converted into the intermediate format by the first converting unit, into the file format that needs to be received by the transmission destination device, and the file transmitting unit transmits, to the transmission destination device, the target data that has been converted into the file format that needs to be received by the transmission destination device.

Exemplary embodiments of the present invention also provide a non-transitory computer-readable medium having computer readable program codes for causing an information processing apparatus to serve as a data transmission device that is capable of communicating with multiple devices via a network, the program codes when executed causing the information processing apparatus to serve as: a first converting unit that converts data into a predetermined intermediate format in accordance with a print command; multiple second converting units that convert data into different file formats in accordance with a print command; a transmission-destination determining unit that determines that any of the devices is a transmission destination device; a file transmitting unit that transmits data to the transmission destination device; and a format setting unit that sets a file format that needs to be received by each device in accordance with designation from each device, wherein when receiving a print command for target data, the first converting unit converts the target data into the intermediate format and activates the transmission-destination determining unit, the transmission-destination determining unit determines the transmission destination device in accordance with activation by the first converting unit, determines a file format that needs to be received by the transmission destination device, and gives a print command to any one of the second converting units, which is capable of conducting conversion into the determined file format, when receiving a print command from the transmission-destination determining unit, the second converting unit converts the target data, converted into the intermediate format by the first converting unit, into the file format that needs to be received by the transmission destination device, and the file transmitting unit transmits, to the transmission destination device, the target data that has been converted into the file format that needs to be received by the transmission destination device.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram that illustrates a data transmission system according to a first embodiment of the present invention;

FIG. 2 is a diagram that illustrates functional configurations of an information processing apparatus and a device according to the first embodiment;

FIG. 3 is a diagram that illustrates configurations of a virtual printing unit, a setting unit, and a receiving unit according to the first embodiment;

FIG. 4 is a diagram that illustrates the information that defines the correspondence relationship between the device and the file format according to the first embodiment;

FIG. 5 is a diagram that illustrates the information that defines the correspondence relationship between the file format and a second converting unit according to the first embodiment;

FIG. 6 is a diagram that illustrates an example of the setting screen for the file format according to the first embodiment;

FIG. 7 is a diagram that illustrates a sequence during data transmission by the data transmission system according to the first embodiment;

FIG. 8 is a diagram that illustrates a sequence during setting of a file format by the data transmission system according to the first embodiment;

FIG. 9 is a diagram that illustrates a sequence during settings of a file format by the data transmission system according to a modified example of the first embodiment;

FIG. 10 is a diagram that illustrates a configuration of the virtual printing unit according to a second embodiment of the present invention;

FIG. 11 is a diagram that illustrates the information that defines the correspondence relationship between the file format and the device according to the second embodiment;

FIG. 12 is a diagram that illustrates a sequence during settings of the file format by the data transmission system according to the second embodiment;

FIG. 13 is a diagram that illustrates configurations of the virtual printing unit, the setting unit, and the receiving unit according to a third embodiment of the present invention;

FIG. 14 is a diagram that illustrates a sequence during data transmission by the data transmission system according to the third embodiment; and

FIG. 15 is a diagram that illustrates an example of the hardware configuration of the information processing apparatus.

### DETAILED DESCRIPTION OF THE PREFERRED EMBODIMENTS

With reference to the attached drawings, a detailed explanation is given below of an embodiment of the present invention.

### First Embodiment

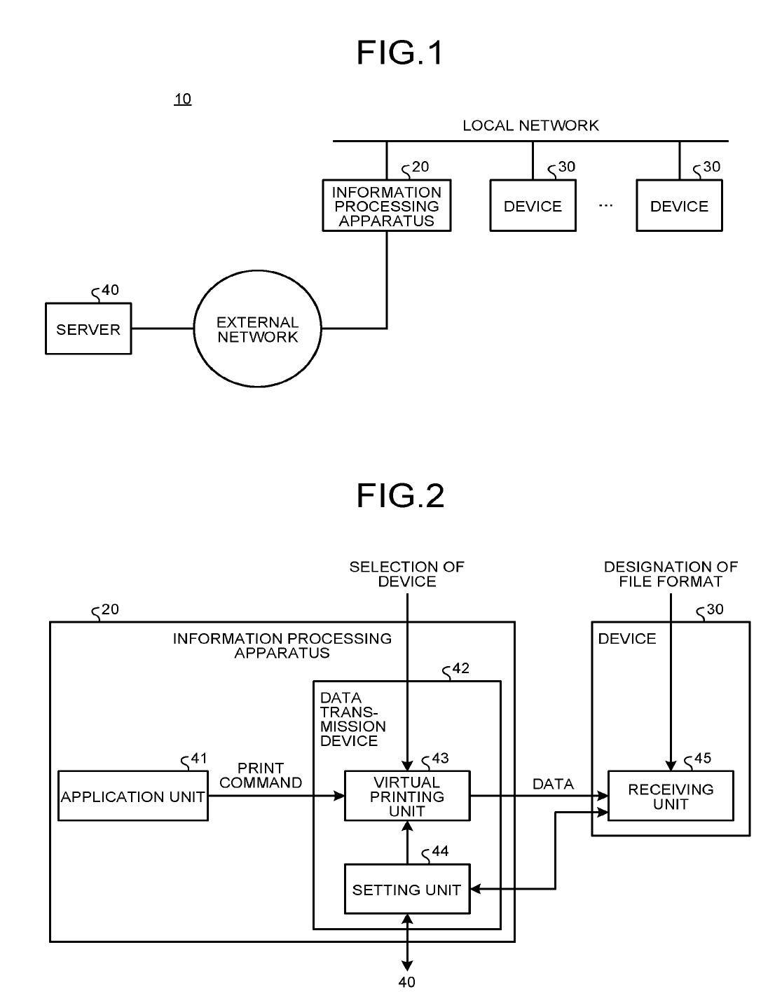

FIG. 1 is a diagram that illustrates a data transmission system 10 according to the first embodiment. The data transmission system 10 includes an information processing apparatus 20, multiple devices 30, and a server 40.

The information processing apparatus 20 is a computer that has a data input function, a display function, and a communication function. The information processing apparatus 20 implements an operating system. Furthermore, the information processing apparatus 20 executes an application program in the operating system.

Each of the devices 30 is a device that has a data input function, a display function, and a communication function. The device 30 may be a computer, or a mobile terminal, such as smartphone, tablet, or mobile phone. The server 40 is a computer that has a communication function, and it provides information to a different device via an external network.

The information processing apparatus 20 is capable of communicating with each of the devices 30 via a local network. Furthermore, the information processing apparatus 20 is capable of communicating with the server 40 via an external network, such as the Internet. Here, the information processing apparatus 20 may be capable of communicating with the device 30 via an external network, or it may be capable of communicating with the server 40 via a local network.

FIG. 2 is a diagram that illustrates functional configurations of the information processing apparatus 20 and the device 30 according to the first embodiment. The information processing apparatus 20 includes an application unit 41 and a data transmission device 42.

The application unit 41 provides a user with information processing, such as text editing. The application unit 41 is implemented when the information processing apparatus 20 executes an application program in the operating system. If data is to be printed from a designated printer, the application unit 41 gives a print command to a corresponding printer driver installed in the operating system.

The data transmission device 42 includes a virtual printing unit 43 and a setting unit 44.

The virtual printing unit 43 receives a print command from the application unit 41. When the virtual printing unit 43 receives a print command from the application unit 41, it converts data, which is the target to be printed, into intermediate format data and then determines the device 30, which is the transmission destination, in accordance with a user's selection. Next, the virtual printing unit 43 converts the intermediate format data into the file format that needs to be received by the determined transmission destination, which is the device 30, and transmits it to the transmission destination, the device 30. Furthermore, with regard to each of the devices 30, the virtual printing unit 43 previously stores the file format that needs to be received by the device 30.

The above-described virtual printing unit 43 converts the file format and transmits it in accordance with the print command that is received from the application unit 41. The virtual printing unit 43 is implemented when the information processing apparatus 20 executes an application program, a virtual printer driver, and a computerized driver.

Here, the virtual printer driver performs the same operation (e.g., it is invoked by a print command, and it receives print settings, or the like) as that of the printer driver for the application. However, the virtual printer driver is different from typical printer drivers in that it does not perform a control so as to transmit the generated data to a printer. Instead of transmitting the generated data to a printer, the virtual printer driver writes the generated data (intermediate data) into a predetermined memory area so that it may be acquired by a computerized driver.

Furthermore, the computerized driver also performs the same operation as that of the printer driver for the application. However, instead of transmitting the generated data to the printer, the computerized driver writes it into a predetermined memory area within the information processing apparatus. Furthermore, the computerized driver may convert the data (intermediate data), generated by the virtual printer driver, into a data format other than the data format that may be output to a typical printer.

Furthermore, the printer driver needs to perform an operation in accordance with the flow that is previously determined by the operating system. If the printer driver performs an operation different from the previously determined flow in midstream, the operating system notifies an error, or the like, to the user who is operating the information processing apparatus.

The virtual printing unit 43 causes a user to perform the same operation as that during printing, and it serves as a printer driver for the application. However, the virtual printing unit 43 performs an operation (e.g., the operation to change the file format in accordance with the device 30) that is not performed by typical printer drivers. Therefore, as the virtual printer driver, the virtual printing unit 43 first receives data from the application, generates intermediate data, and temporarily terminates the operation as the printer driver. Then, the virtual printing unit 43 performs the operation (e.g., determination of the device 30 as a transmission destination, or the like) that is not performed by typical printer drivers. Next, the virtual printing unit 43 causes another computerized driver to perform an operation as a printer driver again. That is, the virtual printing unit 43 performs operations as a printer driver twice. Thus, the virtual printing unit 43 looks to the user, who is operating the information processing apparatus, as if the printer driver performs an operation different from normal, although it may prevent the operating system from making error notifications, or the like.

In response to an inquiry from the device 30, the setting unit 44 sends an inquiry to the server 40 about the list of file formats that are transmittable from the virtual printing unit 43, acquires it, and transmits the list, acquired from the server 40, to the device 30. In this case, the server 40 generates the list that also includes a file format that is transmittable if the information processing apparatus 20 installs a new computerized driver.

After transmitting the list, the setting unit 44 receives the designated file format that needs to be received by the device 30. Then, the setting unit 44 sets, in the virtual printing unit 43, the file format that needs to be received by the device 30. Here, if the virtual printing unit 43 has no computerized driver installed therein for conversion into the file format that needs to be received by the device 30, the setting unit 44 downloads the corresponding program from the server 40 and installs it in the information processing apparatus 20.

The above-described setting unit 44 may be implemented by using, for example, Web Application Programming Interface (WebAPI).

The device 30 includes a receiving unit 45. The receiving unit 45 receives, from the virtual printing unit 43, the data that has been converted into the file format that needs to be received by the device 30 (itself). The receiving unit 45 outputs the received data to an external unit or stores it in a storage device.

Furthermore, the receiving unit 45 acquires, from the setting unit 44, the list of file formats that are transmittable from the virtual printing unit 43 and presents it to the user. In this case, the receiving unit 45 may remove the file format, which is not receivable by itself, from the list of file formats that are transmittable from the virtual printing unit 43 and may present it to the user. Then, the receiving unit 45 receives the selected file format from the user and designates, to the setting unit 44, the file format that needs to be received by the device 30.

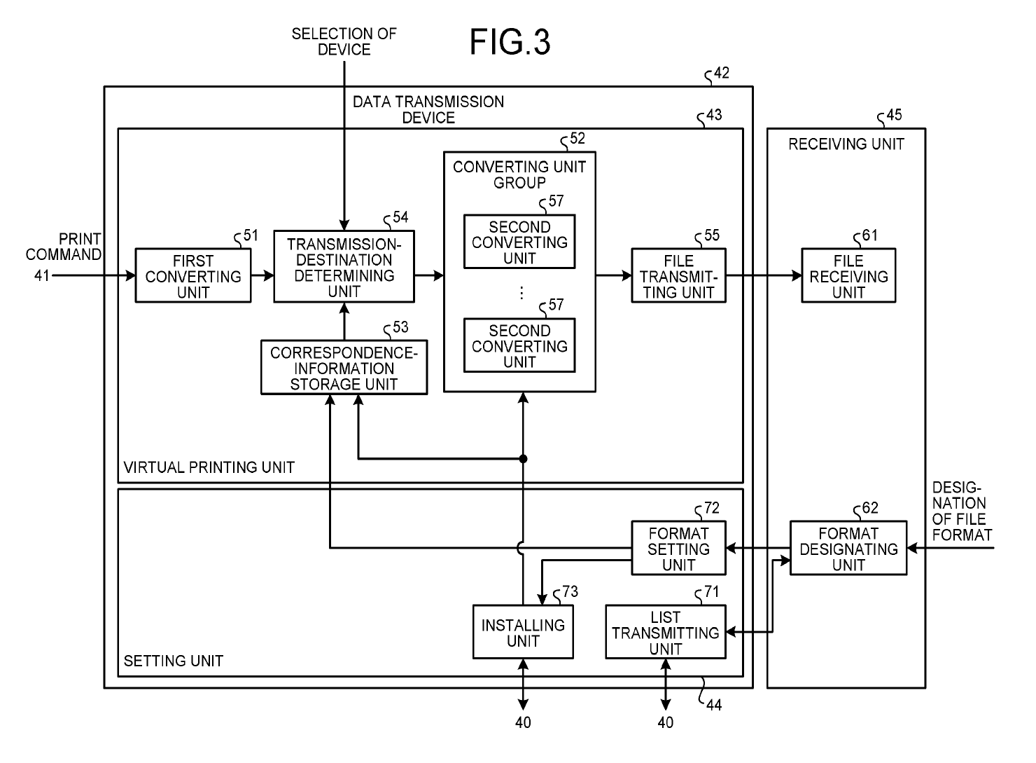

FIG. 3 is a diagram that illustrates configurations of the virtual printing unit 43, the setting unit 44, and the receiving unit 45 according to the first embodiment. The virtual printing unit 43 includes a first converting unit (virtual printer driver), a converting unit group 52 (computerized driver group), a correspondence-information storage unit 53, a transmission-destination determining unit 54, and a file transmitting unit 55.

The first converting unit 51 is implemented when the information processing apparatus 20 executes the virtual printer driver. The first converting unit 51 provides the application unit 41 with the same interface as that of the printer driver, and it receives a print command from the application unit 41. In response to a print command from the application unit 41, the first converting unit 51 converts the print target data into a predetermined intermediate format. Then, after converting the target data into an intermediate format, the first converting unit 51 activates the transmission-destination determining unit 54.

The converting unit group 52 includes multiple second converting units 57. Each of the second converting units 57 is implemented when the information processing apparatus 20 executes the computerized driver. In response to a print command from the transmission-destination determining unit 54, each of the second converting units 57 converts the intermediate format data, which has been converted by the first converting unit 51, into a different file format. Then, after converting the intermediate format data into a predetermined file format, each of the second converting units 57 gives a transmission command to the file transmitting unit 55.

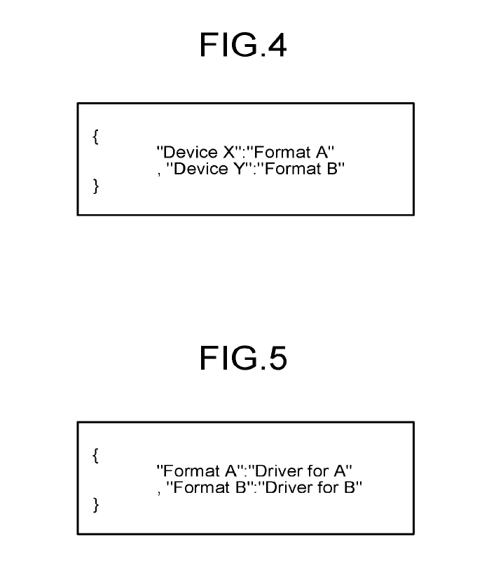

The correspondence-information storage unit 53 stores, with regard to each of the devices 30, the file format that needs to be received by the corresponding device 30. FIG. 4 is the information that defines the correspondence relationship between the device 30 and the file format, stored in the correspondence-information storage unit 53. In FIG. 4, the correspondence relationship between the device 30 and the file format is described in the JSON format. FIG. 4 illustrates that the file format that needs to be received by “device X” is “format A” and the file format that needs to be received by “device Y” is “format B”.

Furthermore, the correspondence-information storage unit 53 stores, with regard to each of the file formats that are transmittable from the virtual printing unit 43, any of the second converting units 57 that are capable of converting the intermediate data into the corresponding file format. FIG. 5 is a diagram that illustrates the information that defines the correspondence relationship between the file format and the second converting unit 57. In FIG. 5, the correspondence relationship between the file format and the second converting unit 57 is described in the JSON format. FIG. 5 illustrates that “format A” is generated by “driver for A” and “format B” is generated by “driver for B”.

The transmission-destination determining unit 54 determines that any one of the devices 30 is a transmission destination device in accordance with the activation by the first converting unit 51. When the transmission-destination determining unit 54 is activated by the first converting unit 51, it provides the user with the selection screen for the device 30 and receives the selected device 30 from the user via the selection screen. Then, the transmission-destination determining unit 54 determines that the device 30, selected by the user, is the transmission destination device. As described above, after a print command is received from the application unit 41, the transmission-destination determining unit 54 may cause the user to select the transmission destination device.

After the transmission destination device is selected, the transmission-destination determining unit 54 determines the file format that needs to be received by the transmission destination device. The transmission-destination determining unit 54 determines the file format that needs to be received by the transmission destination device on the basis of the information that defines the correspondence relationship between the device 30 and the file format, stored in the correspondence-information storage unit 53. Furthermore, after the file format that needs to be received by the transmission destination device is determined, the transmission-destination determining unit 54 determines any one of the second converting units 57, which is capable of converting it into the determined file format. For example, the transmission-destination determining unit 54 determines the second converting unit 57 on the basis of the information that defines the correspondence relationship between the file format and the second converting unit 57, stored in the correspondence-information storage unit 53.

Then, the transmission-destination determining unit 54 gives a print command to the determined second converting unit 57. After the second converting unit 57 receives the print command from the transmission-destination determining unit 54, it converts the intermediate format data, generated by the first converting unit 51, into the file format that needs to be received by the transmission destination device. Furthermore, after the second converting unit 57 receives the print command from the transmission-destination determining unit 54, it gives a transmission command to the file transmitting unit 55.

In response to the transmission command, received from the second converting unit 57, the file transmitting unit 55 transmits the data, converted by the second converting unit 57, to the transmission destination device that is determined by the transmission-destination determining unit 54.

The receiving unit 45 includes a file receiving unit 61 and a format designating unit 62.

The file receiving unit 61 receives data from the data transmission device 42. In this case, the data that is received by the file receiving unit 61 has the file format that needs to be received for itself. When the file receiving unit 61 receives data, it displays the received data in the display device or stores the received data in the storage device.

The format designating unit 62 transmits an inquiry about the file format to the setting unit 44 in accordance with a user's operation. As a reply to the inquiry, the format designating unit 62 receives, from the setting unit 44, the list of file formats that are transmittable from the virtual printing unit 43. Then, the format designating unit 62 removes the file format, which is not receivable by itself, from the list of file formats that are transmittable from the virtual printing unit 43 and presents it to the user. Here, the format designating unit 62 previously stores the list of file formats that are receivable by itself.

The format designating unit 62 receives the file format that needs to be received and that is selected from the presented list. After the file format is selected, the format designating unit 62 transmits the information, indicating the selected file format, to the setting unit 44 via a network, thereby designating the file format that needs to be received by itself to the setting unit 44.

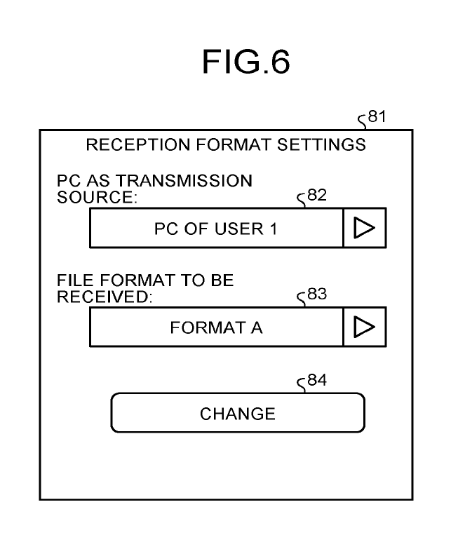

The format designating unit 62 may use a setting screen 81, illustrated in FIG. 6, to designate the file format that needs to be received for itself. For example, in FIG. 6, the user determines any one of the information processing apparatuses 20 in a transmission source box 82. After any one of the information processing apparatuses 20 is determined, the format designating unit 62 sends an inquiry to the corresponding information processing apparatus 20 to acquire the list of transmittable file formats. The format designating unit 62 presents, in a format box 83, the list that is obtained by removing, from the acquired list of transmittable file formats, the file format that is not receivable by itself. The user designates the file format, which needs to be received, from the list that is presented in the format box 83. Then, when a change button 84 is pressed by the user while any one of the file formats is designated, the format designating unit 62 transmits the information, indicating the designated file format, to the setting unit 44 of the corresponding information processing apparatus 20.

The setting unit 44 includes a list transmitting unit 71, a format setting unit 72, and an installing unit 73.

In response to an inquiry from the format designating unit 62 of the device 30, the list transmitting unit 71 transmits the list of file formats that are transmittable from the virtual printing unit 43. In this case, the list transmitting unit 71 makes an inquiry (access) to the server 40 via a network to notify the server 40 of the type of operating system that is executed in the information processing apparatus 20, which serves as the data transmission device 42.

For example, the server 40 stores the computerized drivers that correspond to various operating systems. When the server 40 receives an inquiry from the list transmitting unit 71, it searches for the computerized driver that is usable in the notified operating system and returns the list of file formats that are convertible by the computerized driver that is acquired during searching. In this case, the server 40 returns the list that includes the file format that is not transmittable at present as the corresponding computerized driver is not installed in the information processing apparatus 20 but is transmittable after a new computerized driver is installed. Thus, the list transmitting unit 71 acquires the list of transmittable file formats in accordance with the operating system.

The format setting unit 72 receives, from the format designating unit 62 of the device 30, the designated file format that needs to be received by the device 30. In accordance with the designation from the format designating unit 62, the format setting unit 72 sets, in the virtual printing unit 43, the file format that needs to be received by the device 30. For example, the format setting unit 72 updates the information that defines the correspondence relationship between the device 30 and the file format that needs to be received by the device 30, stored in the correspondence-information storage unit 53, thereby setting the file format that needs to be received by the corresponding device 30.

Furthermore, before a print command from the application unit 41, the format setting unit 72 sets the file format that needs to be received by the device 30. Specifically, the format setting unit 72 sets the file format that needs to be received by the device 30 at a timing different from the print command from the application unit 41.

Furthermore, if the converting unit group 52 does not include the second converting unit 57 that conducts conversion into the file format that is designated by the format designating unit 62, the format setting unit 72 gives, to the installing unit 73, a command to install the corresponding computerized driver.

If the converting unit group 52 does not include the second converting unit 57 that conducts conversion into the file format that is designated by the format designating unit 62, the installing unit 73 receives the command to install the corresponding computerized driver from the format setting unit 72. When the installing unit 73 receives the installation command, it downloads the corresponding computerized driver from the server 40 and installs it in the information processing apparatus 20 that serves as the data transmission device 42. Thus, the installing unit 73 may install the second converting unit 57 that conducts conversion into the designated file format as one of them in the converting unit group 52. Furthermore, if the second converting unit 57 that conducts conversion into the designated file format is installed in the converting unit group 52, the installing unit 73 updates the information that defines the correspondence relationship between the file format and the second converting unit 57, stored in the correspondence-information storage unit 53.

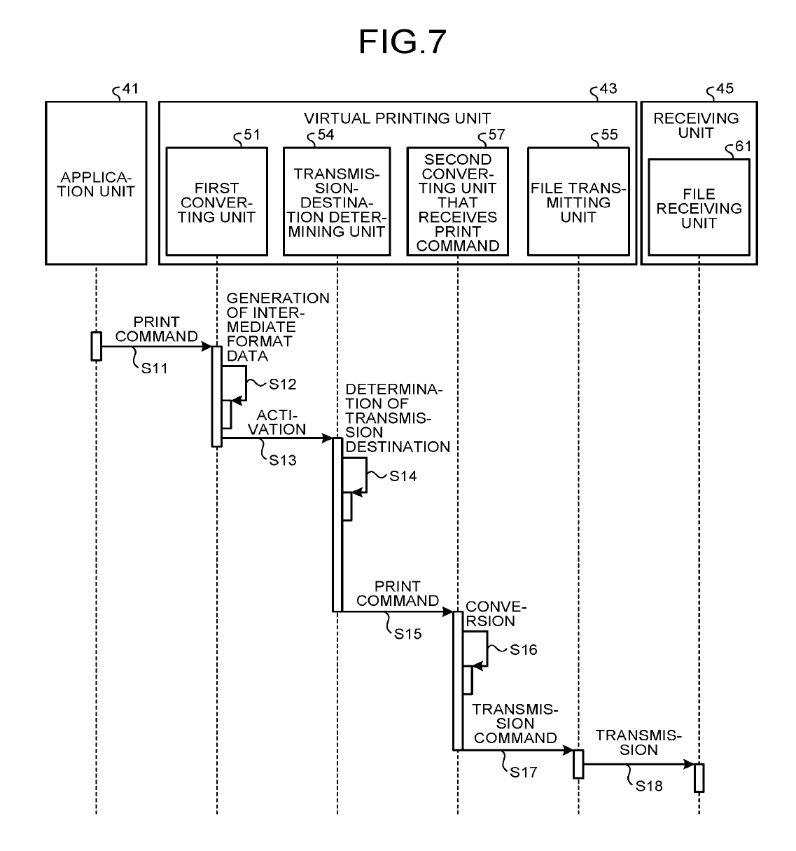

FIG. 7 is a diagram that illustrates a sequence during data transmission by the data transmission system 10 according to the first embodiment. The data transmission system 10 conducts data transmission according to the sequence that is illustrated in FIG. 7.

First, the application unit 41 gives a print command to the first converting unit 51 (step S11). Next, the first converting unit 51 converts the target data into an intermediate format in accordance with the print command (step S12). Then, the first converting unit 51 activates the transmission-destination determining unit 54 (step S13).

The transmission-destination determining unit 54 determines the transmission destination device when it is activated by the first converting unit 51 (S14). More specifically, the transmission-destination determining unit 54 provides the user with the selection screen for the device 30, receives the device 30 that is selected by the user, and determines that the received device 30 is the transmission destination device. Furthermore, the transmission-destination determining unit 54 determines the file format that needs to be received by the transmission destination device on the basis of the information that defines the correspondence relationship between the device 30 and the file format, stored in the correspondence-information storage unit 53. Furthermore, among the second converting units 57, the transmission-destination determining unit 54 determines the second converting unit 57 that conducts conversion into the file format that needs to be received by the transmission destination device on the basis of the information that defines the correspondence relationship between the file format and the second converting unit 57, stored in the correspondence-information storage unit 53.

Next, the transmission-destination determining unit 54 gives a print command to the determined second converting unit 57 (step S15). Then, after receiving the print command, the second converting unit 57 converts the intermediate format data, converted by the first converting unit 51, into the file format that needs to be received by the transmission destination device in accordance with the print command (step S16).

Then, after receiving the print command, the second converting unit 57 gives a transmission command to the file transmitting unit 55 (step S17). After receiving the transmission command from the second converting unit 57, the file transmitting unit 55 transmits the data, converted by the second converting unit 57, to the file receiving unit 61 of the transmission destination device that is determined by the transmission-destination determining unit (step S18).

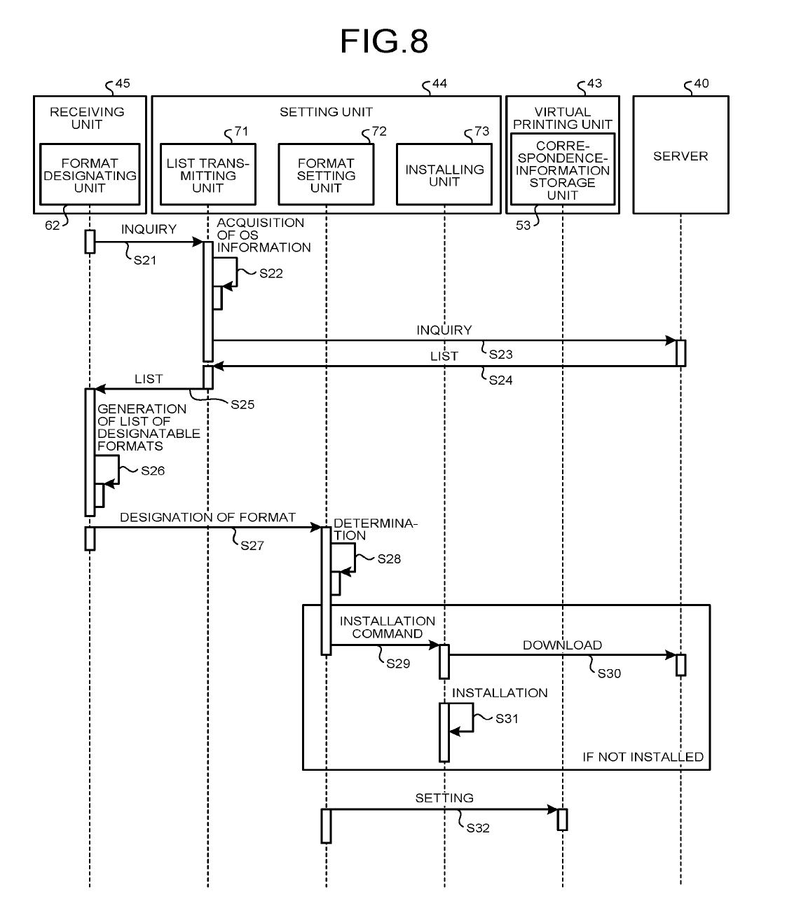

FIG. 8 is a diagram that illustrates a sequence during setting of a file format by the data transmission system 10 according to the first embodiment. The data transmission system 10 makes the setting of the file format that needs to be received by the device 30 according to the sequence that is illustrated in FIG. 8.

First, the format designating unit 62 of the receiving unit 45 sends an inquiry to the list transmitting unit 71 of the setting unit 44 about the file format in accordance with a user's operation (step S21). In response to the inquiry from the format designating unit 62, the list transmitting unit 71 acquires the type of operating system (step S22). Next, the list transmitting unit 71 sends an inquiry to the server 40 about a transmittable file format (step S23). In this case, the list transmitting unit 71 includes the type of operating system (OS) in the inquiry.

When the server 40 receives the inquiry, it searches for the computerized driver that is usable in the operating system and returns the list of file formats that are convertible by the computerized driver that is obtained during searching (step S24). When the list transmitting unit 71 receives the list of file formats, which is returned from the server 40, it returns the list to the format designating unit 62 of the device 30 (step S25).

When the format designating unit 62 receives the list from the list transmitting unit 71, it generates the list of designatable formats, obtained by removing the file format, which is not receivable by itself, from the list of file formats that are transmittable from the virtual printing unit 43 (step S26). That is, the list of designatable formats is the list of file formats that are receivable by itself among the file formats that are transmittable from the virtual printing unit 43.

The format designating unit 62 presents the generated list of designatable formats to the user and receives the selected file format that needs to be received. Then, the format designating unit 62 transmits the file format, selected by the user, to the format setting unit 72 of the setting unit 44 and designates it as the file format that needs to be received for itself (step S27).

When the format setting unit 72 receives the designated file format, it determines whether the second converting unit 57, which conducts conversion into the designated file format, is installed in the converting unit group 52 (step S28).

If the second converting unit 57, which conducts conversion into the designated file format, is not installed in the converting unit group 52, the format setting unit 72 gives an installation command to the installing unit 73 (step S29). When the installing unit 73 receives the installation command, it downloads the corresponding computerized driver from the server 40 (step S30). Then, the installing unit 73 installs the downloaded computerized driver in the information processing apparatus (step S31). Thus, the converting unit group 52 may install the second converting unit 57, which conducts conversion into the file format that needs to be received by the device 30, in the converting unit group 52. Furthermore, if the installing unit 73 installs the new second converting unit 57 in the converting unit group 52, it updates the information that indicates the correspondence relationship between the file format and the second converting unit 57, stored in the correspondence-information storage unit 53.

If the second converting unit 57, which conducts conversion into the designated file format, has been installed in the converting unit group 52, or if it is newly installed during the installation, the format setting unit 72 sets the designated file format as the file format that needs to be received by the corresponding device 30 (step S32). More specifically, the format setting unit 72 updates the information that indicates the correspondence relationship between the device 30 and the file format that needs to be received by the device 30, stored in the correspondence-information storage unit 53.

As described above, in the data transmission system 10 according to the first embodiment, after the print target data is converted into an intermediate format by the first converting unit 51 in accordance with a print command from the application unit 41, the device 30, which is a transmission destination, is determined. Thus, with the data transmission system 10, the application unit 41 may make a print command without selecting the device 30, which is a transmission destination, and the file format; thus, operations are simplified.

Furthermore, in the data transmission system 10 according to the first embodiment, the correspondence relationship between the device 30 and the file format that needs to be received by the device 30 is previously set. Thus, with the data transmission system 10, if the transmission destination is determined, the file format is automatically determined; thus, operations are simplified.

Furthermore, in the data transmission system 10 according to the first embodiment, the list of transmittable file formats is transmitted from the information processing apparatus 20 to the device 30, and the file format to be received is designated from the list. Thus, with the data transmission system 10, it is possible to easily set the file format that needs to be received by the device 30.

Furthermore, the data transmission system 10 according to the first embodiment includes, in the list of file formats that are transmittable from the information processing apparatus 20, the file format that is not transmittable at present but is transmittable after a computerized driver is installed. Hence, with the data transmission system 10, users do not need to manually conduct an installation procedure; thus, operations are simplified.

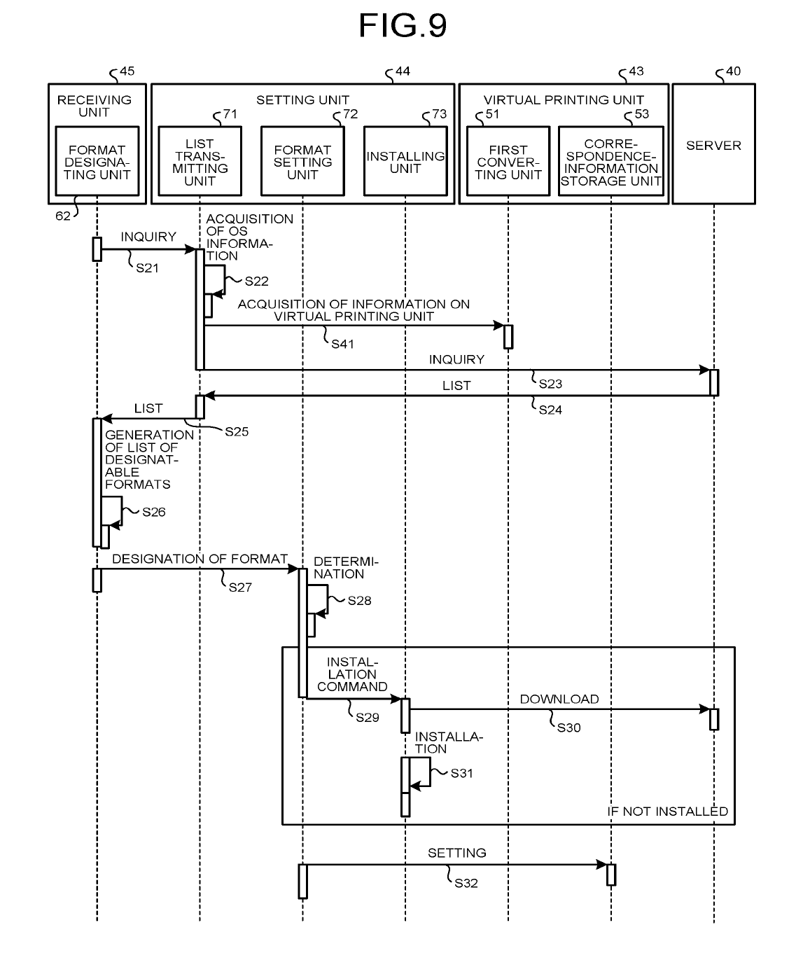

FIG. 9 is a diagram that illustrates a sequence during settings of a file format by the data transmission system 10 according to a modified example of the first embodiment. The data transmission system 10 may execute the sequence illustrated in FIG. 9 instead of the sequence of FIG. 8. Here, as the sequence illustrated in FIG. 9 is substantially the same as the sequence illustrated in FIG. 8, the differences are explained.

After the list transmitting unit 71 acquires the type of operating system at Step S22, the operation proceeds to Step S41. At Step S41, the list transmitting unit 71 acquires the information about the virtual printing unit 43 from, for example, the first converting unit 51. For example, the list transmitting unit 71 acquires the information (e.g., the ID) about the application program for causing the computer to function as the data transmission device 42.

Next, at Step S23, the list transmitting unit 71 notifies the server 40 of the type of operating system and the information about the application program for causing it to function as the data transmission device 42 so as to make an inquiry about transmittable file formats. Then, at Step S24, when the server 40 receives the inquiry, it searches for a computerized driver that is usable in the operating system and the application program and returns the list of file formats that are convertible by the computerized driver that is obtained during searching (step S24).

As described above, the data transmission system 10 according to the modified example of the first embodiment transmits, to the server 40, the information about the application program for implementing the function as the data transmission device 42 so as to acquire the list of file formats. Thus, with the data transmission system 10, if the installable second converting unit 57 is different depending on each application program for implementing the function as the data transmission device 42, the appropriate second converting unit 57 may be installed.

### Second Embodiment

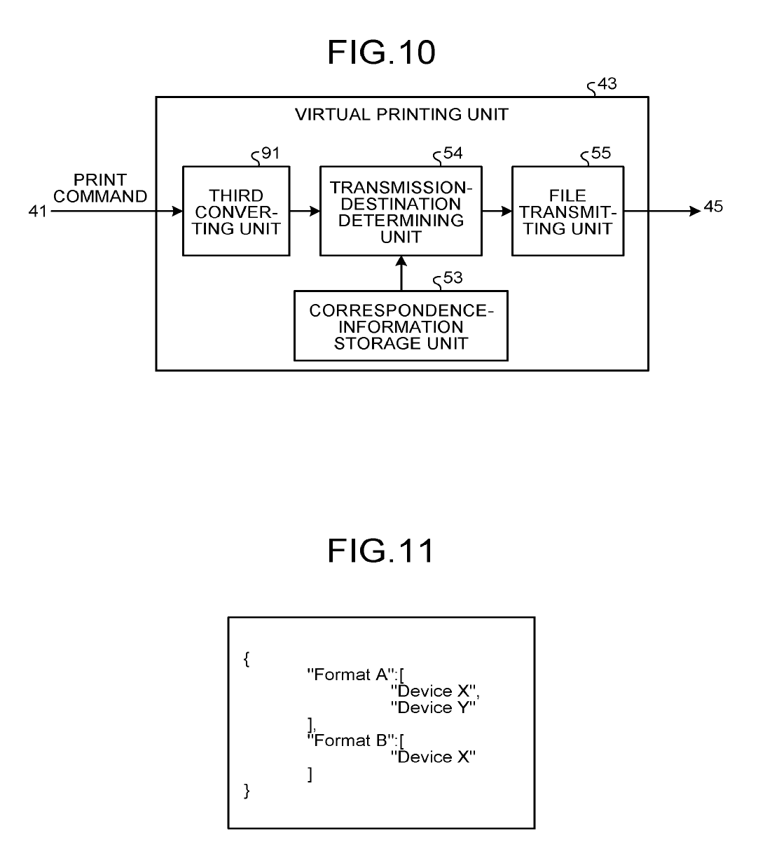

FIG. 10 is a diagram that illustrates a configuration of the virtual printing unit 43 according to a second embodiment of the present invention. The data transmission system 10 according to the second embodiment has substantially the same configuration and function as those in the first embodiment, explained with reference to FIGS. 1 to 9; therefore, the same reference numeral is applied to the component that has substantially the same configuration and function, and explanations are omitted except for the differences.

The virtual printing unit 43 according to the second embodiment includes a third converting unit 91 (virtual printer driver), the correspondence-information storage unit 53, the transmission-destination determining unit 54, and the file transmitting unit 55.

The third converting unit 91 is implemented when the information processing apparatus 20 executes the virtual printer driver. The third converting unit 91 provides the application unit 41 with the same interface as that of the printer driver, and it receives a print command from the application unit 41. In response to a print command from the application unit 41, the third converting unit 91 converts data into a predetermined file format. Then, after converting the target data into the predetermined file format, the third converting unit 91 activates the transmission-destination determining unit 54.

Furthermore, the virtual printing unit 43 may include the multiple third converting units 91 that conduct conversion into different file formats. In this case, the application unit 41 selects the third converting unit 91, corresponding to the file format to be printed, from the third converting units 91 and gives a print command to the selected third converting unit 91.

The correspondence-information storage unit 53 stores, with regard to each of the file formats that are generated by the third converting unit 91, the device 30 that is capable of transmitting the file format. FIG. 11 is a diagram that illustrates the information that defines the correspondence relationship between the file format and the device 30. In FIG. 11, the correspondence relationship between the file format and the device 30 is described in the JSON format. FIG. 11 illustrates that data of “format A” is transmittable to “device X” and “device Y” and data of “format B” is transmittable to “device X”.

According to the second embodiment, the device 30, which is a transmission destination, is determined after the file format is selected; therefore, the multiple devices 30 may be related to the single file format in the information that defines the correspondence relationship between the file format and the device 30. Therefore, with the virtual printing unit 43, all the generable file formats may be related to all the devices 30 that are capable of receiving the file format.

Furthermore, according to the second embodiment, the setting unit 44 may relate the single device 30 to multiple file formats. For example, if “format B” is designated as a receivable file format by the device 30, which is “device X”, while “format A” is related to “device X”, the setting unit 44 may relate “device X” to “format B” while remaining “device X” that is related to “format A” without change.

The transmission-destination determining unit 54 determines that any one of the devices 30 is a transmission destination device in accordance with the activation by the third converting unit 91. When the transmission-destination determining unit 54 is activated by the third converting unit 91, the transmission-destination determining unit 54 provides the selection screen for the device 30 and receives the selected device 30 from the user via the selection screen. In this case, the selection screen presents, as choices, the device 30 that is related to the file format of data, generated by the third converting unit 91. For example, the transmission-destination determining unit 54 presents, in the selection screen, the choices of the devices 30 on the basis of the information that defines the correspondence relationship between the file format and the device 30, stored in the correspondence-information storage unit 53.

Then, the transmission-destination determining unit 54 determines that the device 30, selected by the user, is a transmission destination device, and it gives a transmission command to the file transmitting unit 55. In response to the transmission command that is received from the transmission-destination determining unit 54, the file transmitting unit 55 transmits the data, converted by the third converting unit 91, to the transmission destination device that is determined by the transmission-destination determining unit 54.

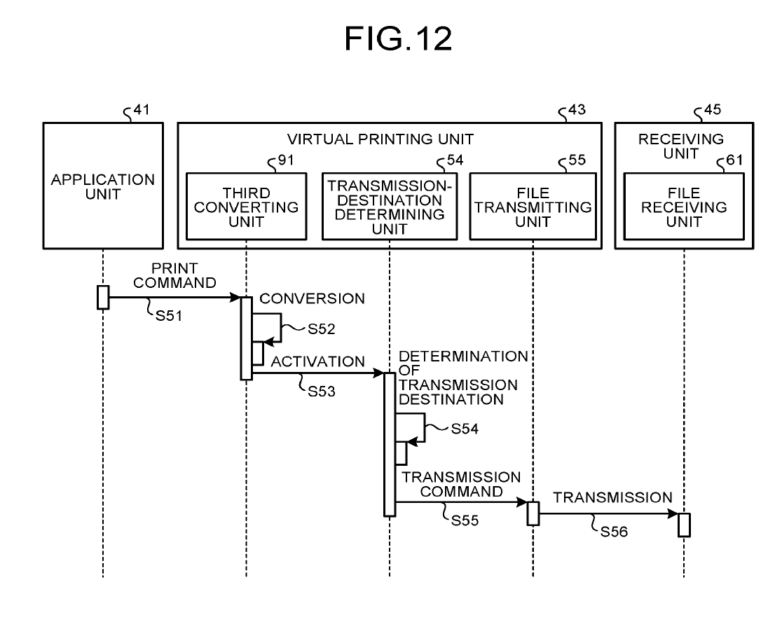

FIG. 12 is a diagram that illustrates a sequence during settings of the file format by the data transmission system 10 according to the second embodiment. The data transmission system 10 according to the second embodiment performs data transmission according to the sequence that is illustrated in FIG. 12.

First, the application unit 41 gives a print command to the third converting unit 91 (step S51). Next, the third converting unit 91 converts the target data into a predetermined file format in accordance with the print command (step S52). Then, the third converting unit 91 activates the transmission-destination determining unit 54 (step S53).

The transmission-destination determining unit 54 determines the transmission destination device when it is activated by the third converting unit 91 (step S54). More specifically, the transmission-destination determining unit 54 provides the user with the selection screen for the device 30, receives the device 30 that is selected by the user, and determines that the received device 30 is the transmission destination device. In this case, the transmission-destination determining unit 54 presents the choices of the devices 30 on the selection screen on the basis of the information that defines the correspondence relationship between the file format and the device 30, stored in the correspondence-information storage unit 53.

Next, the transmission-destination determining unit 54 gives a transmission command to the file transmitting unit (step S55). When the file transmitting unit 55 receives the transmission command from the transmission-destination determining unit 54, it transmits the data, converted by the third converting unit 91, to the file receiving unit 61, which is a transmission destination device that is determined by the transmission-destination determining unit (step S56).

In the data transmission system 10 according to the above-described second embodiment, the information processing apparatus 20 stores each file format such that it is related to the device 30 that is capable of receiving data of the file format. Thus, in the data transmission system 10, if data of a predetermined file format is generated in accordance with a print command from the application unit 41, the device 30 that is capable of transmitting data of the file format may be selected by a user.

### Third Embodiment

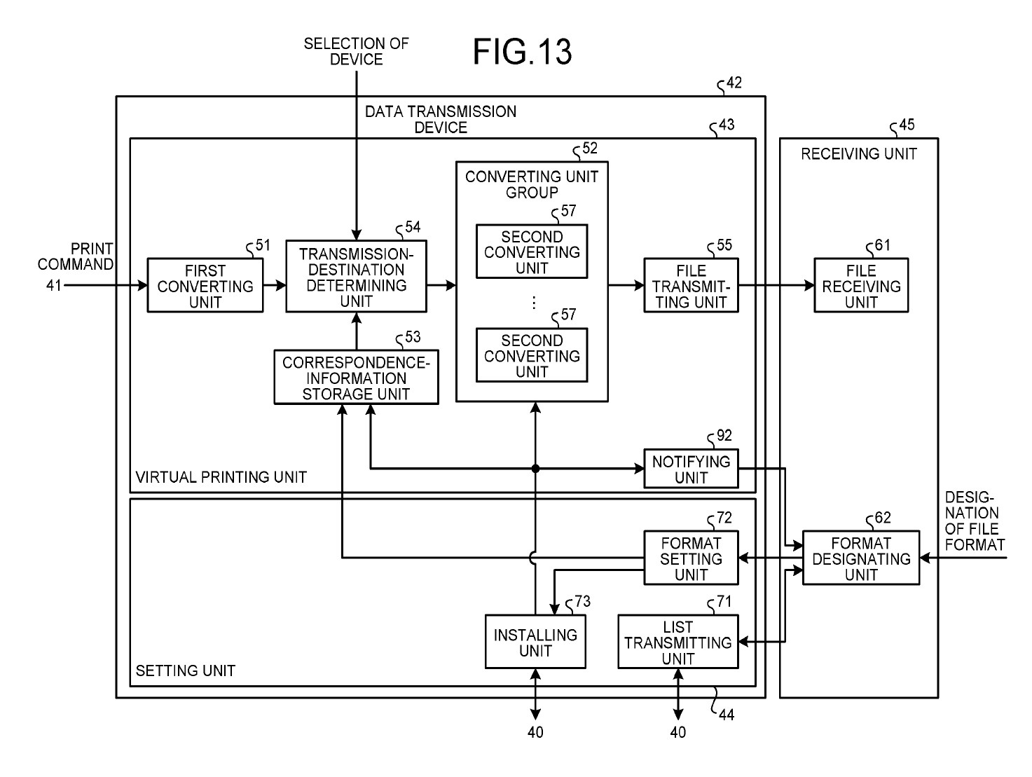

FIG. 13 is a diagram that illustrates configurations of the virtual printing unit 43, the setting unit 44, and the receiving unit 45 according to a third embodiment of the present invention. The data transmission system 10 according to the third embodiment has substantially the same configuration and function as those in the first embodiment, explained with reference to FIGS. 1 to 9; therefore, the same reference numeral is applied to the component that has substantially the same configuration and function, and explanations are omitted except for the differences.

According to the third embodiment, the virtual printing unit 43 further includes a notifying unit 92.

According to the third embodiment, the transmission-destination determining unit 54 activates the notifying unit 92 after the transmission destination device is determined and before the file format is specified. If the transmission-destination determining unit 54 determines the transmission destination device, the notifying unit 92 is activated by the transmission-destination determining unit 54. The notifying unit 92 notifies the format designating unit 62, included in the receiving unit 45 of the determined transmission destination device, that the transmission destination device has been determined as a transmission destination.

In accordance with the notification from the notifying unit 92, the format designating unit 62 sends an inquiry about the file format to the list transmitting unit 71 of the setting unit 44 and designates the file format to be received in the format setting unit 72. In accordance with designation by the format designating unit 62 of the transmission destination device, the format setting unit 72 sets, in the virtual printing unit 43, the file format that needs to be received by the transmission destination device. Also, the format setting unit 72 transmits, to the transmission-destination determining unit 54, the notification that a change in the file format has been completed. In accordance with the notification that a change in the file format has been completed, the transmission-destination determining unit 54 determines the file format that needs to be received by the transmission destination device.

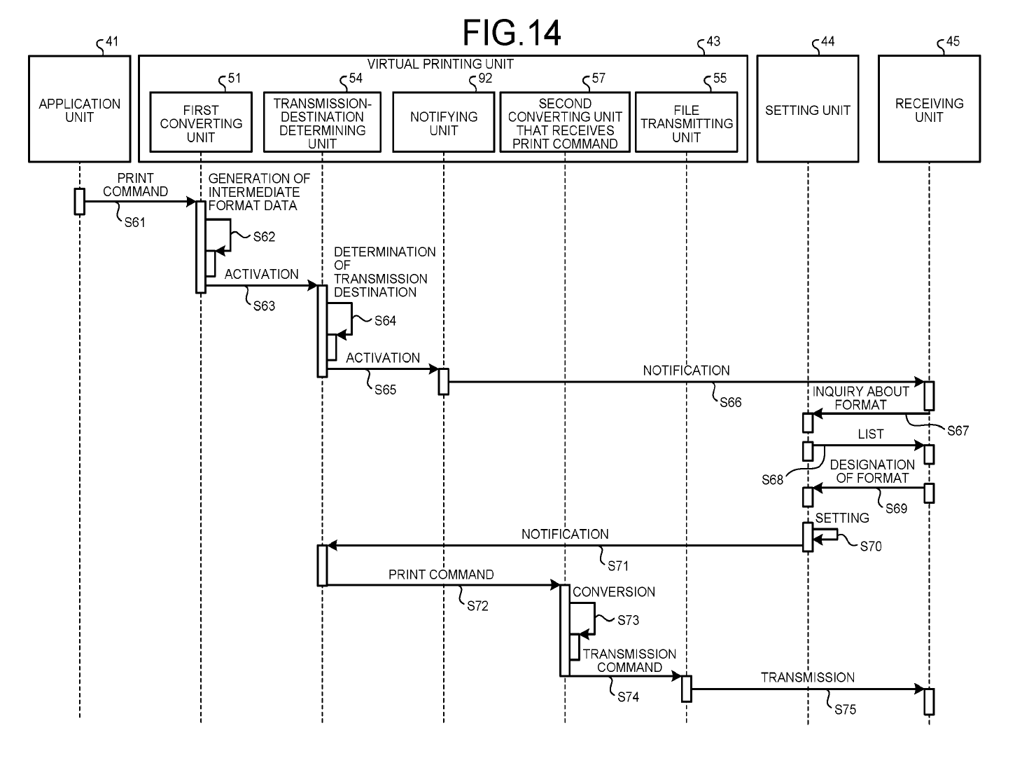

FIG. 14 is a diagram that illustrates a sequence during data transmission by the data transmission system 10 according to the third embodiment. The data transmission system 10 according to the third embodiment performs data transmission according to the sequence that is illustrated in FIG. 14.

First, the application unit 41 gives a print command to the first converting unit 51 (step S61). Next, the first converting unit 51 converts the target data into an intermediate format in accordance with the print command (step S62). Then, the first converting unit 51 activates the transmission-destination determining unit 54 (step S63).

The transmission-destination determining unit 54 determines the transmission destination device when the transmission-destination determining unit 54 is activated by the first converting unit 51 (step S64). More specifically, the transmission-destination determining unit 54 provides the user with the selection screen for the device 30, receives the device 30 that is selected by the user, and determines that the received device 30 is the transmission destination device.

Next, the transmission-destination determining unit 54 activates the notifying unit 92 (step S65). Then, the notifying unit 92 notifies the receiving unit 45 of the determined transmission destination device that the receiving unit 45 has been determined as the transmission destination (step S66).

The receiving unit 45, which receives the notification, is activated in accordance with the notification from the notifying unit 92. If the receiving unit 45 is activated, the receiving unit 45 makes an inquiry about the file format to the list transmitting unit 71 of the setting unit (step S67). In response to the inquiry from the receiving unit 45, the list transmitting unit 71 returns the list of transmittable file formats to the receiving unit 45 (step S68). Here, the operations of the setting unit 44 from Steps S67 to S68 are the same as those at Steps S21 to S25 of FIG. 8.

After the receiving unit 45 receives the list from the list transmitting unit 71, the receiving unit 45 designates, in the setting unit 44, the file format that needs to be received by itself (step S69). Here, the operations of the receiving unit 45 at Steps S68 and S69 are the same as those at Steps S25 to S27 of FIG. 8.

In accordance with the received designation of the file format, the setting unit 44 sets the file format that needs to be received by the transmission destination device (step S70). The operation of the setting unit 44 at Step S70 is the same as that at Steps S27 to S32 of FIG. 8.

Next, the setting unit 44 transmits, to the transmission-destination determining unit 54, the notification that a change in the file format has been completed (step S71).

After the transmission-destination determining unit 54 receives, from the setting unit 44, the notification that a change in the file format has been completed, it determines the file format that needs to be received by the transmission destination device on the basis of the information that defines the correspondence relationship between the device 30 and the file format, stored in the correspondence-information storage unit 53. Furthermore, the transmission-destination determining unit 54 determines the second converting unit 57 that conducts conversion into the file format that needs to be received by the transmission destination device among the multiple second converting units 57 on the basis of the information that defines the correspondence relationship between the file format and the second converting unit 57, stored in the correspondence-information storage unit 53. Then, the transmission-destination determining unit 54 gives a print command to the determined second converting unit 57 (step S72).

Next, after receiving the print command, the second converting unit 57 converts the intermediate format data, converted by the first converting unit 51, into the file format that needs to be received by the transmission destination device in accordance with the print command (step S73). Then, after receiving the print command, the second converting unit 57 gives a transmission command to the file transmitting unit 55 (step S74). After receiving the transmission command from the second converting unit 57, the file transmitting unit 55 transmits the data, converted by the second converting unit 57, to the file receiving unit 61 of the transmission destination device that is determined by the transmission-destination determining unit (step S75).

As described above, in the data transmission system 10 according to the third embodiment, each time the transmission destination device is determined, a notification is made to the transmission destination device that it has been determined as a transmission destination. Thus, with the data transmission system 10 according to the present embodiment, each time data is transmitted to the transmission destination device, it is possible to cause the transmission destination device to designate the file format.

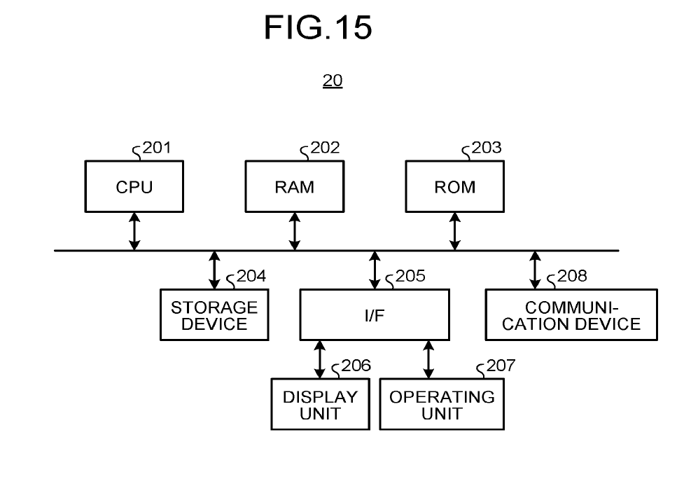

FIG. 15 is a diagram that illustrates an example of the hardware configuration of the information processing apparatus 20. The information processing apparatus 20 according to the first embodiment to the third embodiment is implemented by using, for example, the hardware configuration of a typical computer, illustrated in FIG. 15. Furthermore, the device 30 and the server 40 may have the same hardware configuration.

The information processing apparatus 20 includes a central processing unit (CPU) 201, a random access memory (RAM) 202, a read only memory (ROM) 203, a storage device 204, an I/F 205, a display unit 206, an operating unit 207, and a communication device 208. Furthermore, the above units are connected via a bus.

The CPU 201 is a processor that executes calculation operations, control operations, or the like, in accordance with programs. The CPU 201 performs various operations in cooperation with programs that are stored in the ROM 203, the storage device 204, or the like, by using a predetermined area of the RAM 202 as a working area.

The RAM 202 is a memory, such as a synchronous dynamic random access memory (SDRAM). The RAM 202 serves as a working area of the CPU 201. The ROM 203 is a memory that stores programs and various types of information such that they may not be rewritten.

The storage device 204 is a device that writes and reads data to and from a storage medium, including a semiconductor, such as a flash memory, a storage medium that is magnetically or optically recordable, or the like. The storage device 204 writes and reads data to and from a storage medium under the control of the CPU 201.

The I/F 205 is an interface for connecting the display unit 206 and the operating unit 207 to the bus. The display unit 206 is a display device, such as a liquid crystal display (LCD). The display unit 206 displays various types of information on the basis of the display signal from the CPU 201. The operating unit 207 is an input device, such as a mouse and a keyboard. The operating unit 207 receives the information, input due to a user's operation, as a command signal and outputs the command signal to the CPU 201. The communication device 208 communicates with a different device via a network under the control of the CPU 201.

The program that is executed by the information processing apparatus 20 according to the present embodiment includes a first conversion module, a transmission-destination determination module, a correspondence-information storage module, multiple second conversion modules, a file transmission module, a list transmission module, a format setting module, and an installation module. The program is loaded into the RAM 202 and is executed by the CPU 201 (processor), whereby the information processing apparatus functions as the first converting unit 51, the multiple second converting units 57, the correspondence-information storage unit 53, the transmission-destination determining unit 54, the file transmitting unit 55, the list transmitting unit 71, the format setting unit 72, and the installing unit 73.

Furthermore, the information processing apparatus 20 is not limited to the above-described configuration, and a configuration may be such that at least some of the first converting unit 51, the multiple second converting units 57, the correspondence-information storage unit 53, the transmission-destination determining unit 54, the file transmitting unit 55, the list transmitting unit 71, the format setting unit 72, and the installing unit 73 are implemented by a hardware circuit (e.g., a semiconductor integrated circuit).

Furthermore, the program that is executed by the information processing apparatus 20 according to the present embodiment is provided by being stored, in the form of a file that is installable and executable by a computer, in a non-transitory computer-readable recording medium such as a CD-ROM, a flexible disk, a CD-R, or a digital versatile disk (DVD).

Furthermore, a configuration may be such that the program that is executed by the information processing apparatus 20 according to the present embodiment is stored in a computer connected via a network such as the Internet and provided by being downloaded via the network. Moreover, a configuration may be such that the program that is executed by the information processing apparatus 20 according to the present embodiment is provided or distributed via a network such as the Internet. Moreover, a configuration may be such that the program that is executed by the information processing apparatus 20 is provided by being previously installed in a ROM, or the like.

According to the exemplary embodiments of the present invention, it is possible to easily set the file format that needs to be received by a device.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A data transmission device that is capable of communicating with multiple devices via a network, the data transmission device comprising:
a first converting unit that converts data into a predetermined intermediate format in accordance with a print command;
multiple second converting units that convert data into different file formats in accordance with a print command;
a transmission-destination determining unit that determines any of the devices as a transmission destination device;
a file transmitting unit that transmits data to the transmission destination device; and
a format setting unit that sets a file format that needs to be received by each device in accordance with designation from each device, wherein
when receiving a print command for target data, the first converting unit converts the target data into the intermediate format and activates the transmission-destination determining unit,
the transmission-destination determining unit determines the transmission destination device in accordance with activation by the first converting unit, determines a file format that needs to be received by the transmission destination device, and gives a print command to any one of the second converting units, which is capable of conducting conversion into the determined file format,
when receiving a print command from the transmission-destination determining unit, the second converting unit converts the target data, converted into the intermediate format by the first converting unit, into the file format that needs to be received by the transmission destination device, and
the file transmitting unit transmits, to the transmission destination device, the target data that has been converted into the file format that needs to be received by the transmission destination device.

2. The data transmission device according to claim 1, wherein
the transmission-destination determining unit determines a device that is selected by a user as the transmission destination device.

3. The data transmission device according to claim 1, further comprising a list transmitting unit that, in response to an inquiry from a device, transmits a list of transmittable file formats to the device that has made the inquiry, wherein
the format setting unit acquires a file format, designated from the list, from the device that has transmitted the list, and sets the acquired file format as a file format that needs to be received by the corresponding device.

4. The data transmission device according to claim 3, wherein
the list transmitting unit accesses a server via a network to acquire the list and transmits the acquired list to the device that has made the inquiry.

5. The data transmission device according to claim 4, wherein
the list transmitting unit notifies the server of a type of operating system that is implemented in an information processing apparatus, which serves as a data transmission device, thereby acquiring the list that corresponds to the operating system.

6. The data transmission device according to claim 4, wherein
the list transmitting unit notifies the server of information about an application program for causing an information processing apparatus to serve as a data transmission device, thereby acquiring the list that corresponds to the application program.

7. The data transmission device according to claim 4, further comprising an installing unit that, when the second converting unit that conducts conversion into a designated file format is not provided, downloads a corresponding computerized driver from the server and installs the corresponding computerized driver in an information processing apparatus that serves as the data transmission device, thereby installing the second converting unit that conducts conversion into the designated file format.

8. The data transmission device according to claim 1, further comprising a notifying unit that makes a notification to the transmission destination device when the transmission-destination determining unit determines the transmission destination device, wherein
the transmission destination device designates a file format to be received in accordance with a notification from the notifying unit, and
the format setting unit sets a file format that needs to be received by the transmission destination device in accordance with designation by the transmission destination device.

9. A data transmission system comprising multiple devices and a data transmission device that is capable of communicating with the devices via a network, wherein
the data transmission device includes
a first converting unit that converts data into a predetermined intermediate format in accordance with a print command;
multiple second converting units that convert data into different file formats in accordance with a print command;
a transmission-destination determining unit that determines that any of the devices is a transmission destination device;
a file transmitting unit that transmits data to the transmission destination device; and
a format setting unit that sets a file format that needs to be received by each device in accordance with designation from each device, wherein
when receiving a print command for target data, the first converting unit converts the target data into the intermediate format and activates the transmission-destination determining unit,
the transmission-destination determining unit determines the transmission destination device in accordance with activation by the first converting unit, determines a file format that needs to be received by the transmission destination device, and gives a print command to any one of the second converting units, which is capable of conducting conversion into the determined file format,
when receiving a print command from the transmission-destination determining unit, the second converting unit converts the target data, converted into the intermediate format by the first converting unit, into the file format that needs to be received by the transmission destination device, and
the file transmitting unit transmits, to the transmission destination device, the target data that has been converted into the file format that needs to be received by the transmission destination device.

10. A non-transitory computer-readable medium having computer readable program codes for causing an information processing apparatus to serve as a data transmission device that is capable of communicating with multiple devices via a network, the program codes when executed causing the information processing apparatus to serve as:
a first converting unit that converts data into a predetermined intermediate format in accordance with a print command;
multiple second converting units that convert data into different file formats in accordance with a print command;
a transmission-destination determining unit that determines that any of the devices is a transmission destination device;
a file transmitting unit that transmits data to the transmission destination device; and
a format setting unit that sets a file format that needs to be received by each device in accordance with designation from each device, wherein
when receiving a print command for target data, the first converting unit converts the target data into the intermediate format and activates the transmission-destination determining unit,
the transmission-destination determining unit determines the transmission destination device in accordance with activation by the first converting unit, determines a file format that needs to be received by the transmission destination device, and gives a print command to any one of the second converting units, which is capable of conducting conversion into the determined file format,
when receiving a print command from the transmission-destination determining unit, the second converting unit converts the target data, converted into the intermediate format by the first converting unit, into the file format that needs to be received by the transmission destination device, and
the file transmitting unit transmits, to the transmission destination device, the target data that has been converted into the file format that needs to be received by the transmission destination device.
